(19) United States
(12) Patent Application Publication
(10) Pub. No.: US 2021/0270750 A1
(43) Pub. Date: Sep. 2, 2021

(54) MEASUREMENT APPARATUS AND METHOD

(71) Applicant: Kioxia Corporation, Minato-ku (JP)

(72) Inventors: Yenting KUO, Sagamihara (JP); Takaki HASHIMOTO, Yokohama (JP)

(73) Assignee: Kioxia Corporation, Minato-ku (JP)

(21) Appl. No.: 16/999,167

(22) Filed: Aug. 21, 2020

(30) Foreign Application Priority Data
Feb. 27, 2020 (JP) 2020-031896

(51) Int. Cl. G01N 21/95; G01N 21/88; G01N 21/956; G06T 7/00

(52) U.S. Cl. CPC G01N 21/9501; G01N 21/8806; G01N 21/956; G06T 2207/30148; G06T 7/001; G01N 2021/8848; G06T 2207/10056; G06T 7/0006

(57) ABSTRACT

A measurement apparatus is provided which includes a wafer stage having an upper surface on which a wafer to be measured is placed; a light source capable of illuminating the upper surface with predetermined light; a light detection portion configured to take an image of the wafer illuminated with the predetermined light by the light source; a polarization element provided between the light source and the wafer stage, or between the wafer stage and the light detection portion; and a controller. The controller takes a difference value between two signals that are obtained based on corresponding types of polarization states, in each of which a first and second element of a Stokes Vector are same, and thus measures an asymmetric structure within the wafer, based on the difference value.

### CROSS-REFERENCE TO RELATED APPLICATIONS

This application is based upon and claims the benefit of priority from Japanese Patent Application No. 2020-031896, filed on Feb. 27, 2020; the entire contents of which are incorporated herein by reference.

### FIELD

Embodiments of this disclosure relate to a measurement apparatus and method.

### BACKGROUND

Some semiconductor devices such as non-volatile memories are configured such that holes are formed and multiple elements are formed in series in each of the holes. In order to highly integrate the elements, an aspect ratio of each of such holes has been increasing. While such holes of higher ratio need to be perpendicular to a wafer surface, some of them are inevitably inclined due to variations in process conditions or the like. Additionally, when one unit element structure having holes is repeatedly formed one on the other, a hole of one element structure may be shifted horizontally in relation to another hole of another element structure vertically adjacent to the one element structure due to variations in process conditions or the like.

### BRIEF DESCRIPTION OF THE DRAWINGS

FIG. 1 is a schematic view of a measurement apparatus according to a first embodiment;

FIG. 2 is a schematic view of an optical measurement system of the measurement apparatus according to the first embodiment;

FIG. 3A illustrates an example of a measurement target of the measurement apparatus according to the first embodiment;

FIG. 3B illustrates another example of the measurement target of the measurement apparatus according to the first embodiment;

FIG. 4A illustrates an inclined hole as the measurement target of the measurement apparatus according to the first embodiment, seen along one direction;

FIG. 4B illustrates the inclined hole as the measurement target of the measurement apparatus according to the first embodiment, seen along another direction;

FIG. 5A is a top view for explaining a positional relationship among a light source, a wafer, and an optical detector in a measurement method according to the first embodiment;

FIG. 5B illustrates an example of a regression expression used in the measurement method according to the first embodiment;

FIG. 6A is a top view for explaining a positional relationship among a light source, a wafer, and an optical detector in a measurement method according to a second embodiment;

FIG. 6B is a schematic view schematically illustrating an inclination amount and an inclination direction of an inclined hole to be measured by the measurement method according to the second embodiment;

FIG. 7 is a schematic view illustrating an inclination amount and an inclination direction of an inclined hole that may be measured, based on a difference value of reflection light intensities, by a measurement method according to modification of the second embodiment;

FIG. 8A is a top views for explaining a positional relationship among a light source, a wafer, and an optical detector in a measurement method according to a fourth embodiment;

FIG. 8B is a top views for explaining a positional relationship among the light source, the wafer, and the optical detector in a measurement method according to the fourth embodiment, in succession to FIG. 8A;

FIG. 8C is a top views for explaining a positional relationship among the light source, the wafer, and the optical detector in a measurement method according to the fourth embodiment, in succession to FIG. 8B;

FIG. 8D is a top views for explaining a positional relationship among the light source, the wafer, and the optical detector in a measurement method according to the fourth embodiment, in succession to FIG. 8C;

FIG. 9 illustrates a table summarizing measurement conditions usable in a measurement method according to an embodiment; and

FIG. 10 is a schematic view illustrating modification of an optical measurement system of the measurement apparatus according to an embodiment.

### DETAILED DESCRIPTION

According to one embodiment of this disclosure, there is provided a measurement apparatus that includes a wafer stage having an upper surface on which a wafer to be measured is placed; a light source capable of illuminating the upper surface with predetermined light; a light detection portion configured to take an image of the wafer illuminated with the predetermined light by the light source; a polarization element provided between the light source and the wafer stage, or between the wafer stage and the light detection portion; and a controller. The controller is configured to take a first difference value between a first signal and a second signal, the first signal being generated by the light detection portion, based on a first reflection light from the wafer on the wafer stage, the wafer being illuminated along a first direction by the light source, the first reflection light having a first polarization state, the second signal being generated by the light detection portion, based on a second reflection light from the wafer on the wafer stage, the wafer being illuminated along the first direction by the light source, the second reflection light having a second polarization state different from the first polarization state, and to identify an asymmetric structure of a pattern within the wafer, based on the first difference value and a regression expression. The polarization element is set such that a first element and a second element of a first Stokes Vector expressing the first polarization state are same as a first element and a second element of a second Stokes Vector expressing the second polarization state, respectively.

Non-limiting, exemplary embodiments of the present disclosure will now be described with reference to the accompanying drawings. In the drawings, the same or corresponding reference marks are given to the same or corresponding members or components, and redundant explanations will be omitted. It is to be noted that the drawings are illustrative of this disclosure, and there is no intention to indicate scale or relative proportions among the members or components, or between thicknesses of various layers. Therefore, the specific thickness or size should be determined by a person having ordinary skill in the art in view of the following non-limiting embodiments.

### First Embodiment

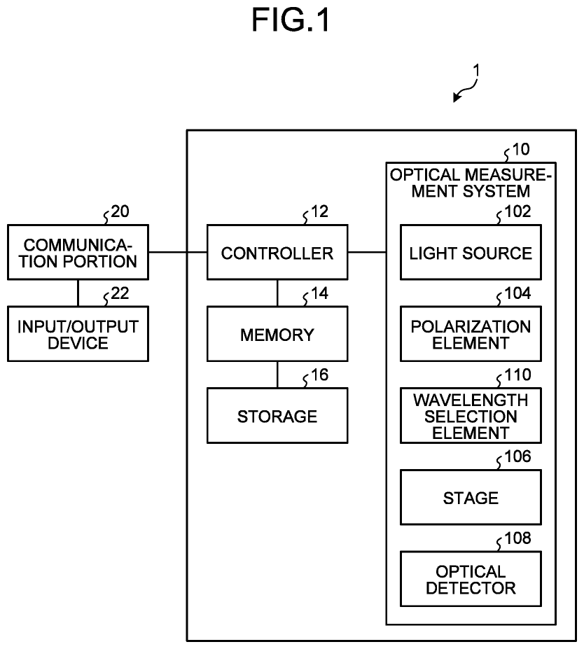

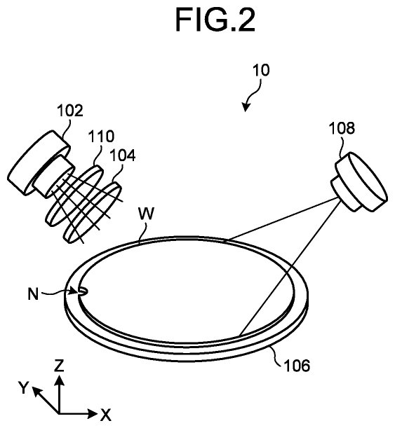

FIG. 1 is a block diagram illustrating a configurational example of a measurement apparatus according to a first embodiment. As illustrated, a measurement apparatus 1 has an optical measurement system 10, a controller 12, a memory 14, and a storage 16. FIG. 2 is a view of a configurational example of the optical measurement system 10 of the measurement apparatus 1.

As illustrated in FIG. 2, the optical measurement system 10 has a light source 102, a polarization element 104, a stage 106, and an optical detector 108. The stage 106 is capable of holding a wafer W on an upper surface thereof by, for example, an electrostatic chuck or a vacuum chuck. The stage 106 is movable forward and backward in an X direction, a Y direction, and a Z direction in the drawing, by a predetermined driving mechanism (not illustrated). Additionally, by such a driving mechanism, the stage 106 is rotatable about a center thereof.

The light source 102 may have, for example, plural white light emitting diodes (LEDs) arranged two-dimensionally. With this, a planar beam, which is expanded two-dimensionally perpendicularly to a light propagating direction, is emitted from the light source 102. The light source 102 is arranged by a predetermined supporting jig (not illustrated) in a position higher than the stage 106 so that a light emitting surface thereof is directed toward the stage 106. By such an arrangement, an entire surface of the wafer W on the stage 106 can be illuminated with the planar light from the light source 102. Incidentally, the light source 102 may be arranged so that an optical axis thereof (or a straight line that is perpendicular to the light emitting surface of the light source 102 and that goes through a center of the light emitting surface) goes through the center of the stage 106.

In this embodiment, a wavelength selection element 110 is arranged to oppose the light emitting surface of the light source 102. The wavelength selection element 110 is changeably arranged, and thus a wavelength of the light to be irradiated onto the wafer W can be selected by changing the wavelength selection elements 110.

Incidentally, the light source 102 may have a lamp such as a high-pressure mercury lamp, a halogen lamp, a xenon lamp, instead of the white LEDs. In this case, an optical system including one or more lenses may be provided in order to improve directional characteristics of the light from the lamp.

Alternatively, the light source 102 may be configured by an LED that emits light of specific wavelength, such as ultraviolet light, blue light, green light, yellow light, or red light, without using the wavelength selection element 110. Even in this case, multiple LEDs may be arranged two-dimensionally.

Moreover, the light source 102 may be configured by a laser device such as a semiconductor laser element or a gas laser apparatus. In this case, an optical system may be used to expand a laser beam emitted from such a laser device in a plane perpendicular to the propagating direction of the laser beam, in order for the laser beam to be irradiated entirely onto the upper surface of the wafer W on the stage 106.

The optical detector 108 illustrated in FIG. 2 is arranged by a predetermined supporting jig (not illustrated) in a position higher than the stage 106 so that a light receiving surface thereof is directed toward the stage 106. Specifically, the optical detector 108 is arranged by the supporting jig so that the entire surface of the wafer W on the stage 106 falls within a field of view of the optical detector 108. Here, the optical detector 108 may optionally be arranged so that an optical axis (or a straight line that is perpendicular to the light receiving surface of the optical detector 108 and that goes through a center of the light receiving surface) goes through the center of the stage 106 and is symmetric to the optical axis of the light source 102 with respect to the central axis of the wafer W. However, without limited to this, the optical axis of the light source 102 and the optical axis of the optical detector 108 may be asymmetric to each other with respect to the central axis of the wafer W, as long as the entire surface of the wafer W falls within the field of view of the optical detector 108.

The optical detector 108 may have an imaging sensor in which multiple imaging elements (pixels), which have an optical sensitivity to the light having a predetermined wavelength emitted from the light source 102, are arranged in a lattice pattern. Such an imaging sensor may be, for example, a charge-coupled device (CCD) sensor or a complementary metal-oxide semiconductor (CMOS) sensor. Output signals from each pixel of the imaging sensor are sent to the controller 12.

The polarization element 104 may be a linear polarization element (light polarizer), which allows only one electric field direction component of light to be transmitted therethrough, or a combination of the linear polarization element and a wavelength plate. The latter may be exemplified as a combination of a ¼ wavelength plate and the linear polarization element. With this, light that has been polarized to linear polarized light by the linear polarization element is further polarized to circularly polarized light after passing through the ¼ wavelength plate.

The polarization element 104 is arranged between the stage 106 and a light emitting surface of the wavelength selection element 110 in this embodiment. The polarization element 104 in this embodiment has a sufficient size that does not prevent light passing through the wavelength selection element 110 from being irradiated onto the entire surface of the wafer W on the stage 106. Moreover, the polarization element 104 is arranged rotatably about a rotational axis, which is the optical axis of the light source 102. With this, a polarization state of the light that has been emitted from the light source 102 and passes through the wavelength selection element 110 becomes adjustable. The polarization element 104 may be rotated by a rotation mechanism (not illustrated), and, for example, rotated based on a control signal from the controller 12 described later.

Incidentally, the polarization element 104 may be arranged between the stage 106 and the optical detector 108. In this case, the polarization element 104 is preferably arranged so that only the light that has passed through the polarization element 104 is incident onto the optical detector 108 without restricting a field of view of the optical detector 108. Additionally, even in this case, the polarization element 104 may be arranged rotatably about the optical axis of the optical detector 108.

The controller 12 controls comprehensively the optical measurement system 10. For example, the controller 12 may cause the stage 106 to move forward and backward in the X direction and the Y direction, to rotate about a rotational axis as the central axis, and to move upward and downward, by controlling the driving mechanism of the stage 106.

The controller 12 may be configured as a computer including a central processing unit (CPU), a read only memory (ROM), a random access memory (RAM) and the like. Alternatively, the controller 12 may be configured of a processor including hardware such as an application specified integrated circuit (ASIC), a programmable gate array (PGA), and a field programmable gate array (FPGA). The computer or the processor can cause the optical measurement system 10 to perform a measurement method described later in accordance with a predetermined computer program and various kinds of data. The computer program and the data may be stored in the memory 14 and/or the storage 16 (described later) and downloaded to the controller 12 therefrom. Additionally, the computer program and the data may be stored in a non-transitory computer readable medium such as a hard disk drive (HDD), a server, and a semiconductor memory, and downloaded to the controller 12 therefrom wirelessly or by wire.

The memory 14 may be configured by a semiconductor memory such as a non-volatile memory. The memory 14 inputs data from the optical measurement system 10 through the controller 12, and stores the input data. Additionally, the memory 14 outputs the stored data to controller 12, which are then processed in the controller 12.

The storage 16 may be configured by an HDD or a semiconductor memory, and mainly store computer programs that causes the optical measurement system 10 to perform the measurement method.

Additionally, as illustrated in FIG. 1, the measurement apparatus 1 is connected to an input/output device 22 through a communication portion 20. The input/output device 22 may be, for example, a personal computer. The input/output device 22 sends and receives signals and data to and from the controller 12 of the measurement apparatus 1, in accordance with a predetermined computer program, and thus comprehensively operates the measurement apparatus 1. The communication portion 20 may be, for example, a wireless or wired router.

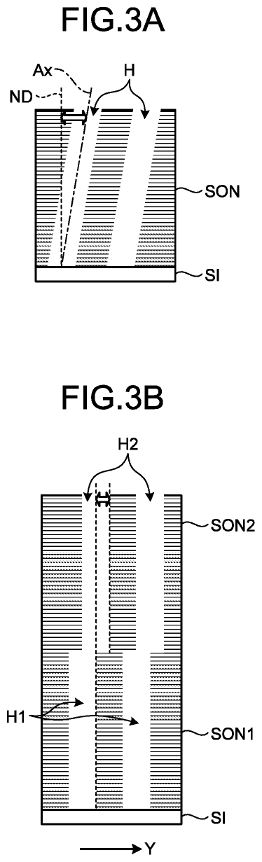

The measurement apparatus 1 according to this embodiment is capable of optically measuring asymmetric structures within the wafer W. Here, the asymmetric structure includes inclination (FIG. 3A) and shift (FIG. 3B) of a hole. FIG. 3A is a view schematically illustrating an example of a measurement target of the measurement apparatus 1 according to this embodiment; and FIG. 3B is a view illustrating another example of the measurement target. In FIG. 3A, a silicon substrate SI and an insulating layer SON formed on the silicon substrate SI are illustrated. The insulating layer SON may be an alternating layer of silicon oxide films and silicon nitride films, and has holes H formed therein. As illustrated, a central axis Ax of the hole H is inclined with respect to a normal direction ND of the silicon substrate SI. In FIG. 3B, the silicon substrate SI, a first insulating layer SON1 formed on the silicon substrate SI, and a second insulating layer SON2 formed on the first insulating layer SON1 are illustrated. Holes H1 penetrate though the first insulating layer SON1; and holes H2 penetrate through the second insulating layer SON2. As illustrated, inner peripheral surfaces of the hole H1 and the hole H2 are shifted to each other in the Y direction in the drawing, while they should have been vertically aligned.

Measurement Principle of Asymmetric Structure

Next, explanations are made about a principle for measuring the above-described asymmetric structures. The following is Stokes Vector S, which is a 4×1 vector representing a polarization state of an incident light to be irradiated onto the wafer W from the light source 102. Here, a first element S₁ indicates a light intensity component; a second element S₂ indicates a horizontal/vertical linear polarization component; a third element S₃ indicates a −45° linear polarization component; and a fourth element S₄ indicates a circular polarization component.

$$S = [ \begin{matrix}{S}_{1} \\ {S}_{2} \\ {S}_{3} \\ {S}_{4}\end{matrix} ]$$

Depending on the polarization states of the light (incident light) to be irradiated onto the wafer W, normalized Stokes Vector is expressed as follows:

Stokes Vector S_{LHP} for horizontally polarized light:

$${S}_{L H P} = [ \begin{matrix}1 \\ 1 \\ 0 \\ 0\end{matrix} ]$$

Stokes Vector S_{LVP} for vertically polarized light:

$${S}_{L V P} = [ \begin{matrix}1 \\ - 1 \\ 0 \\ 0\end{matrix} ]$$

Stokes Vector S_{L+45P} for +45° linearly polarized light:

$${S}_{L + 45 P} = [ \begin{matrix}1 \\ 0 \\ 1 \\ 0\end{matrix} ]$$

Stokes Vector S_{L-45P} for −45° linear polarized light:

$${S}_{L - 45 P} = [ \begin{matrix}1 \\ 0 \\ - 1 \\ 0\end{matrix} ]$$

Stokes Vector S_{RCP} for right circularly polarized light:

$${S}_{R C P} = [ \begin{matrix}1 \\ 0 \\ 0 \\ 1\end{matrix} ]$$

Stokes Vector S_{LCP} for left circularly polarized light:

$${S}_{L C P} = [ \begin{matrix}1 \\ 0 \\ 0 \\ - 1\end{matrix} ]$$

When the incident light expressed by the above Stokes Vectors is irradiated onto and then reflected by the wafer W, a Stokes Vector S′ of the reflection light is expressed as the product of Stokes Vector of the incident light and 4×4 Mueller matrix, as follows:

$${S}^{′} = [ ] [ \begin{matrix}{S}_{1} \\ {S}_{2} \\ {S}_{3} \\ {S}_{4}\end{matrix} ]$$

Here, among Mueller matrix elements, elements M₁₃, M₁₄, M₂₃, and M₂₄ surrounded by a dashed line (referred to as the elements M₁₃ and the like, in some cases in the following) may reflect polarization characteristics due to asymmetric structures within the wafer W. Additionally, elements M₃₁, M₃₂, M₄₁, and M₄₂ which are symmetric elements to the elements M₁₃ and the like, are thought to reflect polarization characteristics due to asymmetric structures.

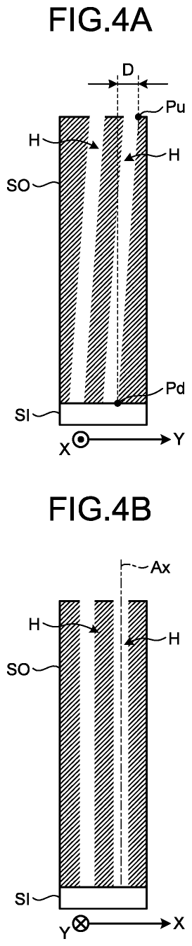

In the following, explanation is made taking the inclined hole illustrated in FIG. 4A as an example. FIG. 4A is a view illustrating an example of the inclined holes, seen in a certain direction, as a measurement target of the measurement apparatus 1 according to this embodiment. In FIG. 4A, the wafer W has the silicon substrate SI and a silicon oxide film SO formed thereon, where multiple holes H are formed to penetrate from an upper surface of the silicon oxide film SO through an upper surface of the silicon substrate SI. The holes H are inclined in the Y direction in the drawing with respect to a normal direction of the upper surface of the silicon substrate SI.

Here, an inclination amount of the hole H is defined in this embodiment as a horizontal distance D between a point Pu and a point Pd, as illustrated in FIG. 4A. The point Pu is a point that is located further away along the Y-direction (an inclination direction) than any other point on an upper opening (or brim) of the hole H. The point Pd is a point that is located further away along the Y-direction than any other point on a circle defined by an inner circumferential surface of the hole H, the inner circumferential surface being on the upper surface of the silicon substrate SI. However, the inclination amount may be expressed by an angle between the central axis of the hole H and the normal direction of the silicon substrate SI.

By the hole H inclined in such a manner, the polarization state of the incident light is changed, and thus the reflection light comes to have another polarization state different from the incident light. Such a change appears in the element M₁₃ and the like of the above Mueller matrix. By utilizing this, the measurement method using the measurement apparatus 1 according to this embodiment is performed, and the inclination amount of the hole or the like (an asymmetric structure) is measured as follows.

Incidentally, FIG. 4B is a view of the hole H, which is illustrated in FIG. 4A, seen in the Y direction (the inclination direction). In this case, a central axis Ax of the hole His in agreement with the normal direction of the silicon substrate SI, as illustrated in FIG. 4B, and thus the hole H is not asymmetric. Therefore, when the light is incident onto the wafer W in the Y direction, the polarization state does not change. In other words, it is the inclination in a direction perpendicular to the optical axis of the light source 102 (FIG. 2) that is reflected in the elements M₁₃ and the like of Mueller matrix. However, the direction of the incident light is not necessarily in agreement with the inclination direction. According to this embodiment, an inclination direction in an x-y coordinate on an upper surface of the wafer W can be detected, as described below. Incidentally, even in a case of a shift illustrated in FIG. 3B, asymmetric properties in a direction perpendicular to the direction of the incident light is reflected in the polarization state.

Measurement Method

In the following, a measurement method using the measurement apparatus 1 according to this embodiment is explained. In this measurement method, an image of the wafer W is taken twice by the optical detector 108, respectively using incident light having different polarization states. Additionally, separately from (or prior to) the imaging performed twice, a preliminary experiment is performed, and a regression analysis is performed based on a result of the preliminary experiment. An inclination amount is calculated from the results of the regression analysis and the above-mentioned imaging. In the following, the imaging performed twice is explained first and then acquisition of a regression expression based on the regression analysis is explained, for explanatory convenience.

Incidentally, the following measurement method is performed by the controller 12 of the measurement apparatus 1 controlling each component of the optical measurement system 10 in accordance with instruction signals from the input/output device 22 (FIG. 1).

First Imaging

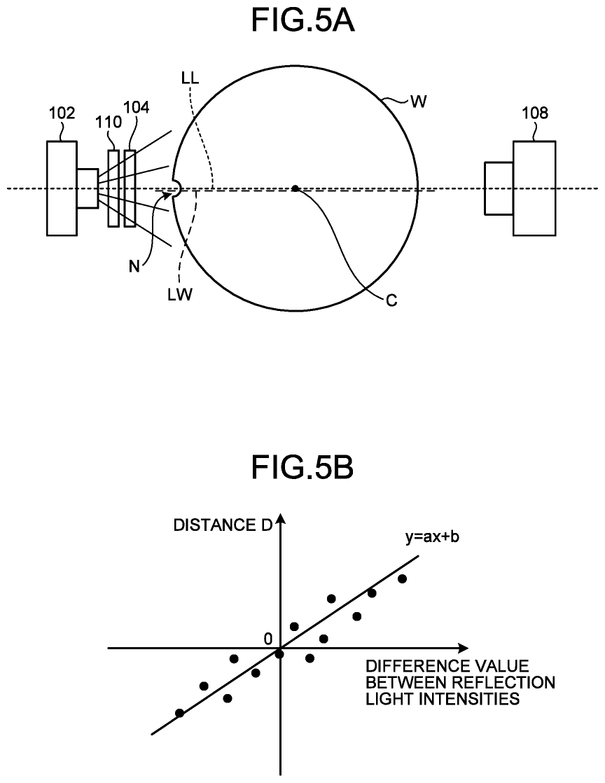

FIG. 5A is a top view for explaining a positional relationship among the light source 102, the wafer W, and the optical detector 108 in the measurement method according to this embodiment. First, the wafer W as the measurement target is placed on the stage 106 of the optical measurement system 10 (FIG. 2). The wafer W may be placed on the stage 106 by an unillustrated transfer mechanism (or a transfer robot) and held onto the stage 106 by a chuck (not illustrated). Here, the wafer W is arranged on the stage 106 in such a manner as illustrated in FIG. 5A. In this arrangement, a straight line LW passing through a central point C and a notch N of the wafer W is in agreement with a straight line LL obtained by projecting the optical axis of the light source 102 onto the wafer W; and the notch N is positioned closer to the light source 102 than to the optical detector 108. When the wafer W is positioned in such a manner, it is expressed that the wafer W is in a first arrangement, in the following for explanatory convenience.

Next, the polarization element 104 as a linear polarization element is adjusted so that the wafer W is illuminated with, for example, the +45° linearly polarized light. Namely, the polarization element 104 is rotated around the optical axis of the light source 102 and thus adjusted so that the wafer W is illuminated with the +45° linearly polarized light. Such adjustment may be performed by the controller 12. However, a user of the measurement apparatus 1 may manually adjust the polarization element 104. Incidentally, a band pass filter having, for example, a central wavelength 550 nm may be used as the wavelength selection element 110.

Next, white light is emitted from the light source 102, and thus the entire surface of the wafer W is illuminated with the (green) +45° linearly polarized light that has passed through the wavelength selection element 110 and the polarization element 104.

Then, the entire surface of the wafer W, which is being illuminated with such light, is imaged by the optical detector 108. With this, signals depending on intensities of received light are generated by corresponding pixels of the image sensor of the optical detector 108. The signals generated by corresponding pixels are stored as reflection light intensities in the memory 14.

The +45° linearly polarized light is expressed by the above Stokes Vector S_{L+45P}, and thus the Stokes Vector of the reflection light is expressed by a product of the Mueller matrix and the Stokes Vector S_{L′45P}, as follows.

$$[ \begin{matrix}{M}_{11} & {M}_{12} & {M}_{13} & {M}_{14} \\ {M}_{21} & {M}_{22} & {M}_{23} & {M}_{24} \\ {M}_{31} & {M}_{32} & {M}_{33} & {M}_{34} \\ {M}_{41} & {M}_{42} & {M}_{43} & {M}_{44}\end{matrix} ] [ \begin{matrix}1 \\ 0 \\ 1 \\ 0\end{matrix} ] = [ \begin{matrix}{M}_{11} + {M}_{13} \\ {M}_{21} + {M}_{23} \\ {M}_{31} + {M}_{33} \\ {M}_{41} + {M}_{43}\end{matrix} ]$$

Here, the optical detector 108 detects intensity of the reflection light, and the light intensity is expressed by the element S₁ (1×1 element) of the Stokes Vector. Namely, the intensity of the reflection light detected by the optical detector 108 indicates the element S₁, which is equal to a sum of the element M₁₁ and the element M₁₃ of the Mueller matrix as indicated in the above expression. In other words, the sum of the element M₁₁ and the element M₁₃ of the Mueller matrix is obtained by each pixel of the imaging sensor of the optical detector 108.

Second Imaging

Next, while the wafer W is maintained in the first arrangement, the second imaging of the wafer W is performed under illumination of a different polarization light. First, the polarization element 104 is adjusted so that the wafer W is illuminated with the −45° linearly polarized light. Then, the white light is emitted from the light source 102, and thus the wafer W is illuminated with the (green) −45° linearly polarized light that has passes through the wavelength selection element 110 and the polarization element 104. Similarly with the first imaging, the wafer W is imaged by the optical detector 108, each pixel of the image sensor of which then generates a signal depending on an intensity of the received light. The signal generated by each pixel is stored as a reflection light intensity signal in the memory 14.

The −45° linearly polarized light is expressed by the above Stokes Vector S_{L-45P}, and thus the Stokes Vector of the reflection light is expressed as follows:

$$[ \begin{matrix}{M}_{11} & {M}_{12} & {M}_{13} & {M}_{14} \\ {M}_{21} & {M}_{22} & {M}_{23} & {M}_{24} \\ {M}_{31} & {M}_{32} & {M}_{33} & {M}_{34} \\ {M}_{41} & {M}_{42} & {M}_{43} & {M}_{44}\end{matrix} ] [ \begin{matrix}1 \\ 0 \\ - 1 \\ 0\end{matrix} ] = [ \begin{matrix}{M}_{11} - {M}_{13} \\ {M}_{21} - {M}_{23} \\ {M}_{31} - {M}_{33} \\ {M}_{41} - {M}_{43}\end{matrix} ]$$

Namely, a value obtained by subtracting the element M₁₃ from the element M₁₁ is obtained in each pixel of the imaging sensor of the optical detector 108. The value obtained by each pixel is stored in the memory 14.

Subsequently, a difference value is taken in each pixel between the reflection light intensity (+45° reflection light intensity) obtained in the first imaging and the reflection light intensity (−45° reflection light intensity) obtained in the second imaging. Specifically, the controller 12 of the measurement apparatus 1 refers to the memory 14; reads out the +45° reflection light intensity (M₁₁+M₁₃) and the −45° reflection light intensity (M₁₁−M₁₃); and obtains the difference value between them, which is 2×M₁₃. By obtaining the difference value, the element M₁₁, which does not reflect the polarization characteristics due to the asymmetric structure, is cancelled out, and thus the element M₁₃, which may reflect the polarization characteristics due to the asymmetric structure, can be extracted. The difference value may be stored in, for example, the memory 14.

The reason why the element M₁₃ is extracted is that the element S₁ of the Stokes Vector of the incident light is the same as “1”, while the element S₃ of the Stokes Vector has the same absolute value of “1” but different signs from each other, between +45° linearly polarized light and −45° linearly polarized light serving as the incident light. Namely, the element M₃₁ of the Mueller matrix, which appears in the element S₁ of the Stokes Vector of the reflection light, is the same between at the time of illuminating the +45° linearly polarized light and at the time of illuminating the −45° linearly polarized light, and thus cancelled out by taking the difference value. On the other hand, the element M₁₃, which also appears in the element S₁ of the Stokes Vector of the reflection light, has the same absolute value with different signs from each other between at the time of illuminating the +45° linearly polarized light and at the time of illuminating the −45° linearly polarized light. Therefore, 2×M₁₃ is obtained by taking the difference value. Namely, in the measurement method according to this embodiment, the polarization element 104 is adjusted so that the Stokes Vectors of the reflection light in the first imaging and in the second imaging have such relationship. Incidentally, while it is (M₁₁+M₁₃) and (M₁₁−M₁₃) that are acquired by the optical detector 108, specific values of the elements M₁₁, M₁₃ are unknown. Nonetheless, the difference value may be greatly influenced by the element M₁₃ that may reflect the polarization characteristics due to the asymmetric structure, because the element M₁₁ has the same sign whereas the element M₁₃ has opposite signs from each other, due to the above-described relationship of the Stokes Vectors between the first imaging and the second imaging.

Acquisition of Regression Expression

The difference value obtained as above includes information on the polarization characteristics due to the asymmetric structure (the inclined hole in the above explanation) within the wafer W, but does not directly indicates the inclination amount. In order to obtain an inclination amount, the following preliminary experiment is performed, and thus a regression expression is obtained which indicates a relationship between the difference value obtained in accordance with the above method and an inclination amount. FIG. 5B illustrates an example of the regression expression to be used in the measurement method according to this embodiment.

In this preliminary experiment, first, a predetermined sample is prepared. This sample, for example, has the same structure as the wafer to be a measurement target of the measurement method according to this embodiment. Here, multiple wafers where the holes H illustrated in FIG. 4A are intentionally formed are used as the sample. Additionally, a range of inclination of the holes H (a range of the above-described distance D) may be, for example, from −30 nm to +30 nm. A range from −30 nm to 0 nm indicates that the holes H are inclined in the −Y direction; and a range from 0 nm to 30 nm indicates that the holes H are inclined in the +Y direction in FIG. 4A. Incidentally, one wafer where plural holes are randomly inclined may be used as the sample, rather than the wafers where the holes H are intentionally formed.

After the sample is prepared, the above-described measurement method is performed on the sample. Incidentally, because the inclination in a direction perpendicular to the incident direction of the incident light is measured in the measurement method, as explained referring to FIG. 4B, when the inclination direction has been known in advance, the incident light may be incident onto the wafer W in the direction perpendicular to the incident direction. In other words, the holes H may be formed in the sample so as to be inclined intentionally in a predetermined direction. When the inclination direction is known, it suffices that the first imaging and the second imaging are performed on the sample, and the difference value is taken between the reflection light intensities obtained in the first imaging and the second imaging.

Then, the sample is cleaved after the difference value is taken, and a cross-sectional image of the holes is obtained by an observation apparatus such as a scanning electron microscope (SEM), a transmission electron microscope (TEM), or the like. Then, based on the cross-sectional image, an inclination amount (a distance D) illustrated in FIG. 4A is measured.

Positions of the holes of which cross-sectional is observed are associated with positions of the holes that has been subject to the measurement method. The positions of the holes subject to the measurement method can be specified by, for example, the positions of the pixels of the image sensor of the optical detector 108. Namely, cross-sectional images of the holes that exist in positions specified by an XY coordinate of the multiple pixels arranged in rows and columns can be observed. With this, the difference value becomes associated with the inclination amount measured based on the cross-sectional observation.

Incidentally, when the cross-sectional observation is performed, the sample may be cleaved in a direction perpendicular to the incident direction of the light incident on the sample. With this, the measurement direction of the measurement method according to this embodiment is in agreement with the observation direction in the cross-sectional observation, according to which the difference value and the inclination amount based on the cross-sectional observation is more assuredly associated with each other.

Next, the difference value obtained for a certain hole according to the above-described measurement method is taken as a horizontal axis, and the distance D (FIG. 4A) measured based on the cross-sectional observation is taken on a vertical axis. When this is repeated plural times, a graph is creased as illustrated in FIG. 5B. Then, in this graph, a regression expression is acquired based on a predetermined regression analysis model. The regression expression may be a linear approximation expression based on the method of least squares.

Incidentally, when the first quadrant in the graph of FIG. 5B indicates that the hole H (FIG. 4A) is inclined towards the +Y direction, the third quadrant indicates that the hole H is inclined towards the −Y direction.

The regression expression (for example, a slope and an intercept) that has been acquired based on the above preliminary explanation is transmitted from the input/output apparatus 22 (FIG. 1) to the controller 12 of the measurement apparatus 1 through the communication portion 20, and then stored in the memory 14 or the storage 16. Once the regression expression is stored in the memory 14 or the storage 16, the controller 12 calculates an inclination amount of the hole in accordance with the difference value stored in the memory 14 and the regression expression. The calculated value may be displayed on, for example, a displaying portion of the input/output apparatus 22.

As explained above, according to the measurement apparatus and the measurement method of this embodiment, the first reflection light intensity is obtained from the wafer illuminated with the first polarization light having a predetermined polarization state. Then, the second reflection light intensity is obtained from the wafer illuminated with a second polarization light having a polarization state that is in a complementary relationship with the predetermined polarization state. Here, it may be referred that two types of polarization light are in a complementary relationship when the elements S₁ and S₂ of the Stokes Vector are the same and at least one of the elements S₃ and S₄ has the same absolute value but different signs between the two types of the polarization light. Then, the difference value between these intensities is calculated. With this, the elements that may reflect the polarization characteristics due to the asymmetric structure, among the Mueller matrix elements, are extracted. Based on the difference value and the regression expression acquired in advance, an inclination amount of the hole as the asymmetric structure is obtained.

Additionally, according to this embodiment, because the wafer illuminated with the incident light having a predetermined polarization state is only imaged, the measurement method can be performed in a short time period. Moreover, because the entire surface of the wafer is illuminated with the light from the light source and imaged by the optical detector, the entire surface of the wafer can be imaged at a time. Furthermore, because the entire surface of the wafer can be imaged at a time, an area where the inclination of the hole tends to occur in the wafer can be found. Additionally, because the measurement method according to this embodiment is optical measurement, there is no need for cleaving the wafer in order to measure an inclination amount in each measurement, which may eliminate unnecessary operations and time. Moreover, the measurement apparatus according to this embodiment may be simply constructed with the light source, the polarization element, the stage, the optical detector, and the controller.

The measurement apparatus and the measurement method may be used, for example, when determining process conditions for forming the holes. The process conditions may include, for example, a flow rate of etching gases, a temperature of the wafer, a pressure in an etching chamber at the time of etching, and a high frequency power in the RIE method. When the hole may be formed with various process conditions and an inclination amount of the hole is repeated calculated, a preferable process condition may be determined in a short time period, because there is no need for cleaving the wafer and observing the holes formed in the wafer.

Additionally, the measurement apparatus and the measurement method may be used for process quality control. For example, when the wafers having holes with a predetermined aspect ratio formed therein is measured with the elapse of time, a trend-chart regarding an inclination amount may be created. With such a trend-chart, a gradual increase of an inclination amount may be noticed at an early time. Moreover, before an inclination amount exceeds a predetermined acceptable value, it becomes possible to stop using a particular etching apparatus used for forming the holes in concern. With this, defective wafers may be prevented in advance from being produced.

### Second Embodiment

Next, a measurement method according to a second embodiment is explained. The measurement method according to the second embodiment is performed subsequent to the measurement method according to the first embodiment, using the measurement apparatus according to the first embodiment. In other words, in the beginning, the first imaging and the second imaging are performed where the wafer W is in the first arrangement, and an inclination amount of the hole H is calculated. For explanatory convenience, this inclination amount is referred to an inclination amount TV1.

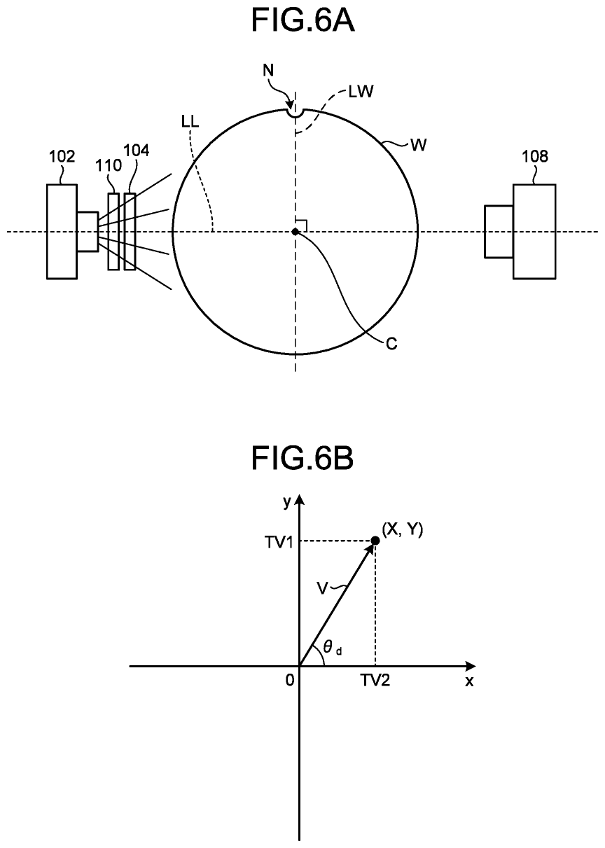

Next, the stage 106 (FIG. 2) is rotated by 90°, and thus the wafer is arranged in a position shifted by 90° in relation to the first arrangement as illustrated in FIG. 6A. FIG. 6A is a top view for explaining a positional relationship among the light source 102, the wafer W and the optical detector 108 in the measurement method according to this embodiment. For explanatory convenience, this position is referred to as a second arrangement hereinafter. When the wafer W is rotated from the first arrangement to the second arrangement, the wafer W may be rotated, for example but not limited to, in a clockwise direction, seen from the above. Then, the wafer W is entirely illuminated with the +45° linearly polarized light and an intensity of reflection light therefrom is acquired (a third imaging); and subsequently the wafer W is entirely illuminated with the −45° linearly polarized light and an intensity of reflection light therefrom is acquired (a fourth imaging). Namely, the intensity of the reflection light from the wafer W illuminated with the polarization light having the same polarization state is acquired in the first imaging and the third imaging; and the intensity of the reflection light from the wafer W illuminated with the light having the same polarization state is acquired in the second imaging and the fourth imaging. Next, the difference value (2×M₁₃) is obtained from the intensities of the reflection light acquired in the third imaging and the fourth imaging.

Then, based on this difference value and the regression expression used to calculate the inclination amount TV1, an inclination amount is calculated. For explanatory convenience, this inclination amount is referred to as an inclination amount TV2. Here, because the wafer is in the first arrangement (FIG. 5A) in the first imaging and the second imaging, the inclination amount TV1 indicates an inclination amount of the hole H in a direction perpendicular to the line LW in FIG. 5A. On the other hand, because the wafer is in the second arrangement (FIG. 6A) in the third imaging and the fourth imaging, the inclination amount TV2 indicates an inclination amount of the hole H in a direction perpendicular to the line LW in FIG. 6A. Namely, the inclination amount TV1 and the inclination amount TV2 indicate inclination amounts in directions different from each other by 90°.

As illustrated in FIG. 6B, when the inclination amount TV1 and the inclination amount TV2 obtained from a predetermined pixel are taken along a y-axis and an x-axis, respectively, a magnitude of a vector V, i.e., (TV1²+TV2²)^{1/2}, indicates an actual inclination amount of the hole H captured by the pixel, and a direction of the vector V indicates an inclination direction of the hole H. FIG. 6B is a schematic view illustrating an inclination amount and an inclination direction of an inclined hole measured by the measurement method according to this embodiment. An angle θ_{d} between the inclination direction and the x-axis is obtained, for example, from tan θ_{d}=Y/X (=TV1/TV2) as illustrated in FIG. 6B, assuming that a coordinate of an endpoint of the vector V is (X, Y). The inclination amount and the angle θ_{d} obtained as above may be stored in the memory 14. Incidentally, the x-axis corresponds to the line LW (FIGS. 5A, 6A) that connects the notch N and the center C of the wafer W.

As explained above, even in the measurement method according to the second embodiment, the +45° linearly polarized light and the −45° linearly polarized light are used, where these two types of the linearly polarized light satisfy a relationship in that the elements S₁ and S₂ of the Stokes Vector are the same and at least one of the elements S₃ and S₄ has the same absolute value but different signs from each other between two types of the polarization light. By using such two types of linearly polarized light, the difference value between the first reflection light intensity obtained when the wafer W is illuminated with the +45° linearly polarized light (at the time of the third imaging) and the second reflection light intensity obtained when the wafer W is illuminated with the −45° linearly polarized light (at the time of the fourth imaging) is obtained. With this, the element among the Mueller matrix elements that may reflect the polarization characteristics due to the asymmetric structure can be extracted. Then, this difference value and the regression expression acquired in advance can be used to obtain an inclination amount of the hole as an asymmetric structure.

Additionally, in this embodiment, the third imaging and the fourth imaging are performed after the first imaging and then the second imaging when the wafer W is in the second arrangement shifted by 90° with respect to the first arrangement, while the first imaging and the second imaging are performed when the wafer W is in the first arrangement. Therefore, two inclination amounts can be obtained which are in two directions different from each other by 90°. With this, the actual inclination amount of the hole H as the measurement target and the in-plane (two-dimensional) inclination direction within the wafer W can be obtained.

As explained referring to FIG. 4B, when the incident light happens to be in agreement with an inclination direction of the hole H, an inclination amount is not measured. Therefore, there may exist a hole H that is measured to be uninclined when the first imaging and the second imaging are only performed. However, because inclination amounts in directions different from each other by 90° can be measured according to this embodiment, presence or otherwise of inclination and the inclination amount can be assuredly measured.

### Modification of Second Embodiment

In the second embodiment, the actual inclination amount and the inclination direction are obtained based on the inclination amount TV1 obtained from the first imaging and the second imaging and the inclination amount TV2 obtained from the third imaging and the fourth imaging. However, the actual inclination amount and the inclination direction are obtained based on difference value between the reflection light intensities.

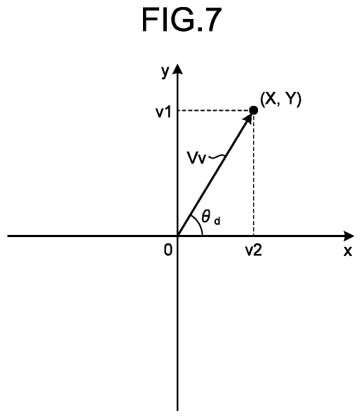

FIG. 7 is a schematic view illustrating an inclination amount and an inclination direction of an inclined hole that may be measured, based on the difference value of the reflection light intensities, by the measurement method according to modification of the second embodiment. As illustrated in FIG. 7, when a difference value v1 obtained from the first imaging and the second imaging, where the wafer W is in the first arrangement, is taken along a y-axis, and a difference value v2 obtained from the third imaging and the fourth imaging, where the wafer W is in the second arrangement, is taken along an x-axis. In this case, a magnitude of a vector Vv, which is (v1²+v2²)^{1/2}, indicates a value corresponding to an actual inclination amount; and a direction of the vector Vv indicates an inclination direction. Therefore, the magnitude of the vector V (FIG. 6B), which corresponds to the actual inclination amount, is directly calculated based on the magnitude of the vector Vv and the above-described regression expression. Additionally, an angle θ_{d} between the inclination direction and the x-axis can be obtained from, for example, tan θ_{d}=Y/X (=v1/v2), assuming that a coordinate of an endpoint of the vector Vv is (X, Y).

According to this modification, the magnitude of the vector Vv is obtained from the difference values v1, v2, and then the actual inclination amount is calculated based on the magnitude of the vector Vv and the regression expression. Therefore, there is no need for calculating the inclination amounts TV1 and TV2 (i.e., magnitudes of an X component and a Y component of the vector V) corresponding to the difference values v1, v2, respectively, which thus allows for a reduced measurement time.

### Third Embodiment

While the +45° linearly polarized light and the −45° linearly polarized light have been selected as two types of polarization light in the complementary relationship in the above embodiments and modification, without limiting to these, other types of polarization light may be used. In a third embodiment, a right circularly polarized light and a left circularly polarized light are selected. In this case, as the polarization element 104 (FIG. 2), a combination of a linear polarization element and a ¼ wavelength plate may be used. For example, as a first imaging, the wafer W illuminated with the right circularly polarized light is imaged by the optical detector 108, and a reflection light intensity is obtained in each pixel. As explained as above, the Stokes Vector of the right circularly polarized light has an element S₁ of 1, an element S₂ of 0, an element S₃ of 0, and an element S₄ of 1. Therefore, an element S₁ of the Stokes Vector S′ of the reflection light is (M₁₁+M₁₄). Namely, the reflection light intensity obtained in each pixel in the first imaging indicates a sum of the element M₃₁ and the element M₁₄ of the Mueller matrix.

Next, as a second imaging, the wafer W illuminated with the left circularly polarized light is imaged by the optical detector 108, and a reflection light intensity is obtained in each pixel. As explained as above, the Stokes Vector of the left circularly polarized light has an element S₁ of 1, an element S₂ of 0, an element S₃ of 0, and an element S₄ of −1. Therefore, an element S₁ of the Stokes Vector S′ of the reflection light is (M₁₁−M₁₄). Namely, the reflection light intensity obtained in each pixel in the first imaging indicates a value obtained by subtracting the element M₁₄ the element M₁₁ of the Mueller matrix.

Next, a difference value between the reflection light intensities in each pixel is obtained, which is 2×M₁₄. Then, an inclination amount is calculated based on the difference value and a regression expression. Incidentally, this regression expression is acquired by illuminating a predetermined sample with the right circularly polarized light and then the left circularly polarized light thereby to obtain a difference value between the respective reflection light intensities, and then by associating the difference value with an inclination amount obtained by observing a cross-sectional image of the same sample. Subsequently, the wafer W is rotated to the second arrangement, the third imaging is performed in the same manner as the first imaging; and the fourth imaging is performed in the same manner as the second imaging. Then, the difference value between the reflection light intensities obtained by the respective imaging is obtained to be 2×M₁₄. The inclination amount is calculated based on this difference value and the above regression expression. Subsequently, the actual inclination amount is calculated in the same manner as explained referring to FIG. 6B, and then the inclination direction is obtained from the direction of the vector V. Incidentally, as explained referring to FIG. 7, after the vector Vv is obtained based on two difference values of the reflection light intensities, the actual inclination amount and the inclination direction may be obtained.

As explained above, even in the third embodiment, the element that may reflect the polarization characteristics due to the asymmetric structure is extracted by taking the difference value between the reflection light intensities, and an inclination amount is calculated based on the difference value. Therefore, advantages are demonstrated which are the same as those in the measurement apparatus and the measurement method according to the above embodiments and modification.

Additionally, when the circularly polarized light is used as in the third embodiment, the element M₁₄ of the Mueller matrix is extracted. On the other hand, when the ±45° linearly polarized light is used, the element M₁₃ of the Mueller matrix is extracted as explained above. Whether either the element M₁₃ or the element M₁₄ greatly reflects particular polarization characteristics is dependent on an asymmetric structure within the wafer W. Therefore, the circularly polarized light and the linearly polarized light may be selectively used, depending on a measurement target.

### Fourth Embodiment

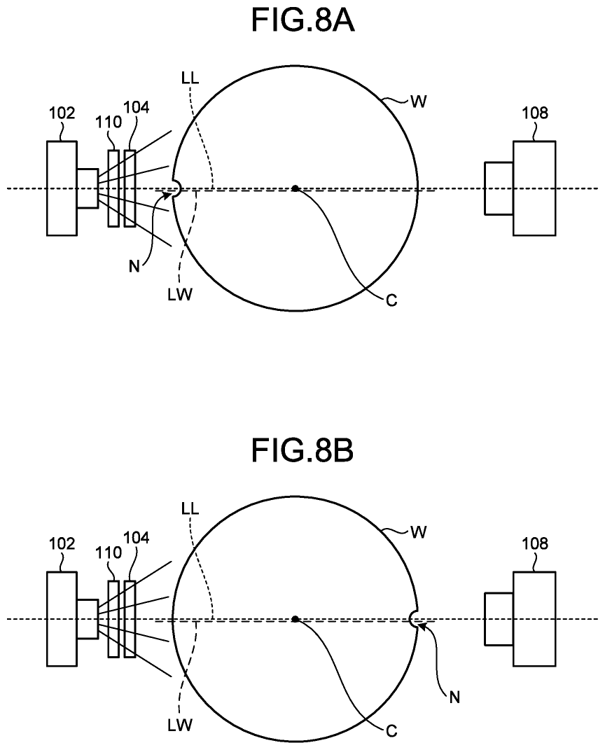

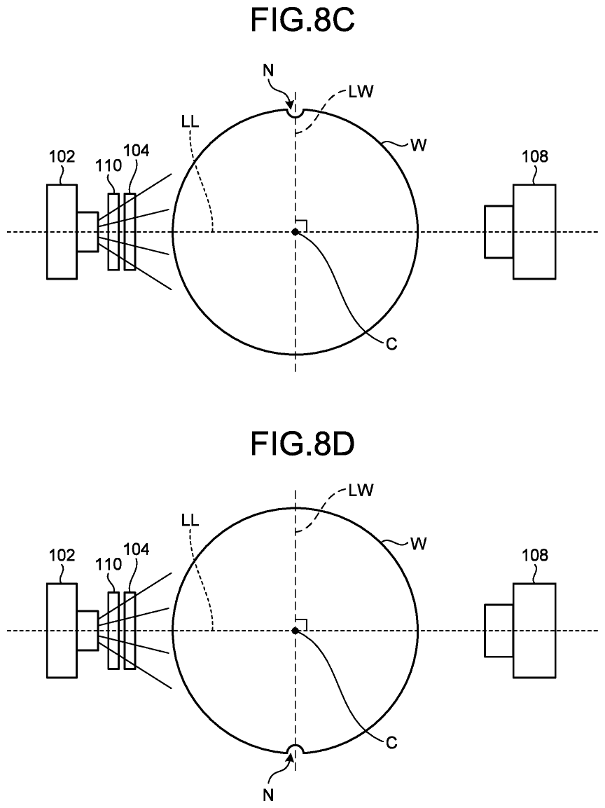

FIGS. 8A through 8D are top views for explaining a positional relationship among the light source 102, the wafer W, and the optical detector 108 in a measurement method according to a fourth embodiment. In the foregoing embodiments and modification, two types of polarization light in the complementary relationship are used. However, in the fourth embodiment, only one polarization light, which is, for example, +45° linearly polarized light is used. Additionally, an incident angle of light incident on the wafer W in a horizontal plane is changed in the first imaging and the second imaging. First, as illustrated in FIG. 8A, the wafer W is arranged in the first arrangement. For explanatory convenience, this position is referred to as a 0° position instead of the first arrangement in this embodiment.

Namely, the wafer W is in the 0° position in the first imaging in this embodiment. Then, the wafer W is illuminated with the +45° linearly polarized light that has passed through the wavelength selection element 110 from the light source 102. The wafer W is imaged by the optical detector 108, and thus the reflection light intensity is obtained in each pixel of the image sensor of the optical detector 108. The reflection light intensity corresponds to a sum of the element M₁₁ and the element M₁₃ of the Mueller matrix.

Next, before the second imaging is performed, the stage 106 (FIG. 2) is rotated by 180°, and thus the wafer W is arranged as illustrated in FIG. 8B. This position of the wafer W is referred to as a 180° position, for explanatory convenience. In this position, the wafer W is illuminated with the +45° linearly polarized light in the same manner as the first imaging. The wafer W is imaged by the optical detector 108, and thus a reflection light intensity is obtained in each pixel of the imaging sensor of the optical detector 108. The reflection light intensity corresponds to a value obtained by subtracting the element M₁₃ from the element M₁₁ of the Mueller matrix.

Then, a difference value is taken between the reflection light intensity obtained in the first imaging and the reflection light intensity obtained in the second imaging, which is 2×M₁₃. While the +45° linearly polarized light is used in both the first imaging and the second imaging in this embodiment, different types of linearly polarized light are substantially used because the incident direction in relation to the wafer W is opposite in the first imaging and the second imaging. Namely, the +45° linearly polarized light at the time of the second imaging substantially equals to the −45° linearly polarized light incident on the wafer W in the 0° position. In such a manner, the element N₁₃ may be extracted even by using only one kind of polarization light. Next, an inclination amount is calculated based on the difference value (2×M₁₃) obtained as above and the regression expression. This regression expression is acquired by performing the first imaging (the 0° position) and the second imaging (the 180° position) while illuminating a predetermined sample with the +45° linearly polarized light, and then by associating a difference value between the respective reflection light intensities with an inclination amount obtained by observing a cross-sectional image of the same sample

Next, at the time of the third imaging, the stage 106 on which the wafer W is placed is rotated by 90° from the 0° position, and thus the wafer W is arranged as illustrated in FIG. 8C. While this position is the same as the second arrangement illustrated in FIG. 6A, this position is referred to as a 90° position here, for explanatory convenience. Then, the wafer W illuminated with the +45° linearly polarized position is imaged by the optical detector 108, and thus a sum of the element M₁₁ and the element M₁₃ of the Mueller matrix is obtained as a reflection light intensity.

Subsequently, at the time of the fourth imaging, the stage 106 is rotated by 180° from the 90° position, and thus the wafer W is arranged as illustrated in FIG. 8D. This position may be referred to as a 270° position. Then, the wafer W illuminated with the +45° linearly polarized light is imaged by the optical detector 108, and thus a value obtained by subtracting the element M₁₃ from the element M₁₁ of the Mueller matrix represents a reflection light intensity.

A difference value is obtained to be 2×M₁₃ between the reflection light intensity obtained when the wafer W is in the 90° position and the reflection light intensity obtained when the wafer W is in the 270° position. Then, an inclination amount is obtained using the same regression expression as above. Subsequently, an actual inclination amount is calculated based on the vector V, as explained referring to FIG. 6B, and an inclination direction is obtained based on a direction of the vector V. Incidentally, as explained referring to FIG. 7, after the vector Vv due to the two difference values is obtained, the actual inclination amount may be calculated, and the inclination direction is obtained from the direction of the vector Vv.

Incidentally, while the +45° linearly polarized light is used in the fourth embodiment, the −45° linearly polarized light, or right circularly polarized light, or left circularly polarized light may be used instead.

### Fifth Embodiment

Next, a measurement method according to a fifth embodiment is explained. In the above-described embodiments, 2×M₁₃ is obtained as a difference value in the first, the second, and the fourth embodiment, and 2×M₁₄ is obtained as a difference value in the third embodiment. In the fifth embodiment, a difference value including the elements M₁₃ and M₁₄ is obtained as follows.

First Imaging

First, in the above-described measurement apparatus 1, the wafer W as a measurement target in the first arrangement (FIG. 5A) is illuminated with +45° linear polarized light by adjusting the polarization element 104. The Stokes Vector of reflection light from the wafer W is expressed as follows:

$$[ \begin{matrix}{M}_{11} & {M}_{12} & {M}_{13} & {M}_{14} \\ {M}_{21} & {M}_{22} & {M}_{23} & {M}_{24} \\ {M}_{31} & {M}_{32} & {M}_{33} & {M}_{34} \\ {M}_{41} & {M}_{42} & {M}_{43} & {M}_{44}\end{matrix} ] [ \begin{matrix}1 \\ 0 \\ 1 \\ 0\end{matrix} ] = [ \begin{matrix}{M}_{11} + {M}_{13} \\ {M}_{21} + {M}_{23} \\ {M}_{31} + {M}_{33} \\ {M}_{41} + {M}_{43}\end{matrix} ]$$

Namely, in the first imaging, an element S₁ of the Stokes Vector of the reflection light, which is (M₁₁+M₁₃), is obtained in each pixel as a reflection light intensity by the optical detector 108 (FIG. 1).

Second Imaging

Next, the polarization element 104 is adjusted again, and the wafer W in the first arrangement is illuminated with the right circularly polarized light. The Stokes Vector of the reflection light from the wafer W is as follows:

$$[ \begin{matrix}{M}_{11} & {M}_{12} & {M}_{13} & {M}_{14} \\ {M}_{21} & {M}_{22} & {M}_{23} & {M}_{24} \\ {M}_{31} & {M}_{32} & {M}_{33} & {M}_{34} \\ {M}_{41} & {M}_{42} & {M}_{43} & {M}_{44}\end{matrix} ] [ \begin{matrix}1 \\ 0 \\ 0 \\ 1\end{matrix} ] = [ \begin{matrix}{M}_{11} + {M}_{14} \\ {M}_{21} + {M}_{24} \\ {M}_{31} + {M}_{34} \\ {M}_{41} + {M}_{44}\end{matrix} ]$$

Namely, in the second imaging, an element S₁ of the Stokes Vector of the reflection light, which is M₁₁+M₁₄, is obtained in each pixel as a reflection light intensity by the optical detector 108.

Next, by taking a difference value between the reflection light intensities obtained at the first imaging and the second imaging, a difference value of (M₁₃−M₁₄) is obtained. With this, the element M₁₃ and the element M₁₄ that may reflect the polarization characteristics due to the asymmetric structure within the wafer W can be extracted. Namely, because the element S₁ of the Stokes Vector of the incident light is “1” for both the +45° linearly polarized light and the right circularly polarized light, the element S₁ of the Stokes Vector of the reflection light includes “M₁₁” of the same sign in both the first imaging and the second imaging. Therefore, the element M₁₁ of the Mueller matrix is cancelled out by taking a difference value. On the other hand, because the elements M₁₃, M₁₄ are different in the +45° linearly polarized light from in the right circularly polarized light, the elements M of the Mueller matrix are not cancelled out and remain in the element S₁ the Stokes Vector of the reflection light.

As explained above, the polarization light used is different in in the first imaging from in the second imaging in the fifth embodiment. Here, between the two types of the polarization light used, the Mueller matrix element appearing in the element S₁ of the Stokes Vector of the reflection light (specifically, light received by the optical detector 108), and not reflecting the polarization characteristics due to an asymmetric structure, is the same. Therefore, such a Mueller matrix element is cancelled out by taking a difference value, and thus the Mueller matrix elements can be extracted which may reflect the polarization characteristics due to the asymmetric structure.

Therefore, as explained referring to FIG. 5B, by associating a difference value (M₁₃−M₁₄) with an inclination amount measured from a cross-section image of the hole H thereby to obtain the regression expression, an inclination amount can be calculated based on the difference value.

As explained above, even in the fifth embodiment, by taking a difference value between the reflection light intensities obtained in the first imaging and in the second imaging, the Mueller matrix elements that reflect the polarization characteristics due to the asymmetric structure can be extracted, and thus the inclination amount is calculated based on the different value. Accordingly, the same advantages effects are demonstrated in the measurement apparatus and the measurement method according to the fifth embodiment as in the foregoing embodiments.

Incidentally, as explained in the second embodiment, the following may be performed. Namely, subsequent to the fifth embodiment, the wafer W is rotated to be in the second arrangement; the third imaging is performed in the same manner as the first imaging of the fifth embodiment; the fourth imaging is performed in the same manner as the second imaging of the fifth embodiment; and then the difference value of (M₁₃−M₁₄) may be obtained from the reflection light intensities obtained in the third imaging and the fourth imaging. Then, the inclination amount is calculated based on the difference value and the regression expression used in the fifth embodiment. Subsequently, the actual inclination amount is calculated based on the calculated two inclination amounts in the same manner as explained referring to FIG. 6B, and then the inclination direction is obtained from the direction of the vector V. Incidentally, as explained referring to FIG. 7, after the vector Vv is obtained based on the two difference values, the actual inclination amount and the inclination direction may be obtained based on the vector Vv and the regression expression.

### Other Embodiments

Next, measurement conditions usable in other embodiments are explained. Because procedures to take a difference value are readily understood from the foregoing explanations, the usable measurement conditions are only explained in the following.

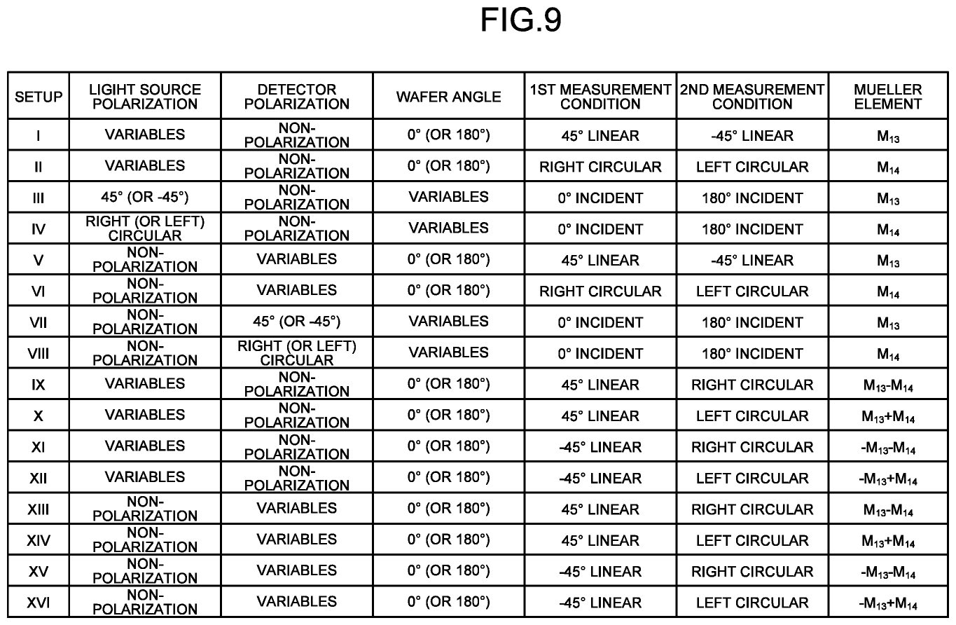

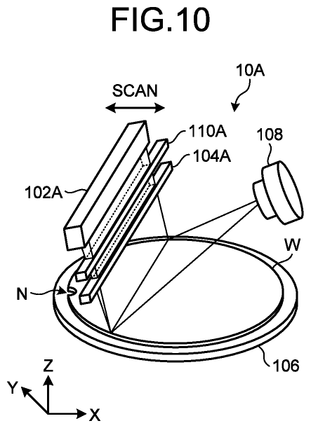

FIG. 9 illustrates a table summarizing measurement conditions usable in a measurement method according to embodiments. In this table, “VARIABLES” indicates that the first (third) imaging is performed under a first measurement condition, and the second (fourth) imaging is performed under a second measurement condition. “LIGHT SOURCE POLARIZATION” indicates that the polarization element 104 is provided between the light source 102 and the wafer W (or the stage 106) and thus the wafer W is illuminated with the polarized light. “OPTICAL DETECTOR POLARIZATION” indicates that the polarization element 104 is provided between the wafer W (or the stage 106) and the optical detector 108 and thus the reflection light from the wafer W is polarized and received by the optical detector 108. Additionally, “WAFER ANGLE” indicates an angle of the incident light onto the wafer W in a horizontal plane. Here, “0°” of “0° (or 180°)” indicates the 0° position illustrated in FIG. 8A and “180°” of “0° (OR 180°)” indicates the 180° position illustrated in FIG. 8B.

For example, in Setup I, because “LIGHT SOURCE POLARIZATION” is “VARIABLES”, the +45° linearly polarized light as the first measurement condition is irradiated onto the wafer Win the first (third) imaging; and the −45° linearly polarized light as the second measurement condition is irradiated onto the wafer W in the second (fourth) imaging by the polarization element 104 provided between the light source 102 and the wafer W. Additionally, because “OPTICAL DETECTOR POLARIZATION” is “NON-POLARIZATION”, no polarization element is provided between the wafer W and the optical detector 108. Moreover, because “WAFER ANGLE” is “0° (OR 180°)”, the wafer is not rotated between the first imaging and the second imaging. However, when the third imaging is performed, the position of the wafer W is changed from the first arrangement to the second arrangement. Namely, when the third imaging and the fourth imaging are performed, while the wafer W is rotated by 90° between the second imaging and the third imaging, the wafer W is not rotated by 180°, as illustrated in FIG. 8A and FIG. 8B, between the first imaging and the second imaging.

Incidentally, the Setup I has been employed in the measurement method according to the embodiment as explained referring to FIG. 5A and/or FIG. 6A. As described above, the Mueller matrix element extracted in the Setup I is M₁₃.

In a Setup II of the table in FIG. 9, “LIGHT SOURCE POLARIZATION” is “VARIABLES”; “OPTICAL DETECTOR POLARIZATION” is “NON-POLARIZATION”; and “WAFER ANGLE” is “0° (OR 180°)”, as is the case with the Setup I. However, polarization light used in the Setup II is different from that in the Setup I. Namely, in the Setup II, the right circularly polarized light as a first measurement condition is used in the first imaging, and the left circularly polarized light as the second measurement condition is used in the second imaging. The Setup II has been employed in the third embodiment described above. In this case, the Mueller matrix element extracted is N₁₄.

In a Setup III of FIG. 9, because “WAFER ANGLE” is “VARIABLES”, the first imaging is performed when the wafer W is in the 0° position (FIG. 8A), and the second imaging is performed when the wafer W is in the 180° position (FIG. 8B). The polarization light is the +45° linearly polarized light generated by the polarization element 104 arranged between the light source 102 and the stage 106, because “LIGHT SOURCE POLARIZATION” is “45° (OR −45°)”, and used from the beginning to the end of the measurement without being changed. However, the −45° linearly polarized light may be used throughout the measurement. The Setup III has been employed in the fourth embodiment described above. The Mueller matrix element extracted in this case is M₁₃.

A Setup IV is different from the Setup III in that the right circularly polarized light (or the left circularly polarized light) is used as the polarization light, but the same as the Setup III in other items.

A Setup V is different from the Setup I in that the polarization light is generated by the polarization element 104 arranged between the wafer W and the optical detector 108 rather than between the light source 102 and the wafer W, but the same as the Setup I in other items. A Setup VI is different from the Setup II in that the polarization light is generated by the polarization element 104 arranged between the wafer W and the optical detector 108 rather than between the light source 102 and the wafer W, but the same as the Setup II in other items.

A Setup VII is different from the Setup III in that the polarization light is generated by the polarization element 104 arranged between the wafer W and the optical detector 108 rather than between the light source 102 and the wafer W, but the same as the Setup III in other items. A Setup VIII is different from the Setup IV in that the polarization light is generated by the polarization element 104 arranged between the wafer W and the optical detector 108 rather than between the light source 102 and the wafer W, but the same as the Setup IV in other items.

In a Setup IX, because “LIGHT SOURCE POLARIZATION” is “VARIABLES”, the +45° linearly polarized light as a first measurement condition is irradiated onto the wafer W in the first (third) imaging and the right circularly polarized light as a second measurement condition is irradiated onto the wafer W in the second (fourth) imaging by the polarization element 104 arranged between the light source 102 and the wafer W. Additionally, because “OPTICAL DETECTOR POLARIZATION” is “NON-POLARIZATION”, no polarization element is arranged between the wafer W and the optical detector 108. Moreover, because “WAFER ANGLE” is “0° (OR 180°)”, the position of the wafer W is the same between at the first imaging and the second imaging. However, when the third imaging and the fourth imaging are performed, the wafer W is rotated by 90° before the third imaging is performed. The Setup IX has been employed in the fifth embodiment, and the element S₁ of the Stokes Vector of the reflection light is (M₁₁+M₁₃) in the first imaging, and (M₁₁+M₁₄) in the second imaging. Therefore, the Mueller matrix element extracted is (M₁₃−M₁₄).

A Setup X is different from the Setup IX in that the second measurement condition is the left circularly polarized light, but the same as the Setup IX in other items. In the second imaging, the left circularly polarized light is irradiated onto the wafer W. Because the Stokes Vector of the left circularly polarized light is [1, 0, 0, −1], the S₁ element of the Stokes Vector of the reflection light is expressed as (M₁₁−M₁₄). In the first imaging, because the S₁ element of the Stokes Vector of the reflection light is (M₁₁+M₁₃), the Mueller matrix element extracted by taking a difference value is (M₁₃+M₁₄).

A Setup XI is different from the Setup IX in that the first measurement condition is the −45° linearly polarized light, but the same as the Setup IX in other items. In the first imaging, the −45° linearly polarized light is irradiated onto the wafer W. Because the Stokes Vector of the −45° linearly polarized light is [1, 0, −1, 0], the S₁ element of the Stokes Vector of the reflection light is expressed as (M₁₁−M₁₃). In the second imaging, because the S₁ element of the Stokes Vector of the reflection light is (M₁₁+M₁₄), the Mueller matrix element extracted by taking a difference value is (−M₁₃−M₁₄).

A Setup XII is different from the Setup IX in that the first measurement condition is the −45° linearly polarized light and the second condition is the left circularly polarized light, but the same as the Setup IX in other items. The element S₁ of the Stokes Vector of the reflection light in the first imaging where the −45° linearly polarized light is used is expressed as (M₁₁−M₁₃), whereas the element S₁ of the Stokes Vector of the reflection light in the second imaging where the left circularly polarized light is used is expressed as (M₁₁−M₁₁). Therefore, the Mueller matrix element extracted by taking a difference value is (−M₁₃+M₁₄).

A Setup XIII is different from the Setup IX in that non-polarized light is emitted from the light source 102 and the polarization light is generated by the polarization element 104 arranged between the wafer W and the optical detector 108, but the same as the Setup IX in other items. Namely, in the Setup XIII, while a position of the polarization element 104 is different from that in the Setup IX, the polarization state of the reflection light that is detected by the optical detector 108 is the same as that in the Setup IX. Therefore, even in the Setup XIII, (M₁₃−M₁₄) is extracted.

Similarly, a Setup XIV is different from the Setup X in that the polarization element 104 is arranged in a different position, but the same as the Setup XIV in other terms. Therefore, even in the Setup XIV, (M₁₃+M₁₄) is extracted. Additionally, a Setup XV is different from the Setup XI in that the polarization element 104 is arranged in a different position, but the same as the Setup XI in other items. Therefore, even in Setup XV, (−M₁₃−M₁₄) is extracted. Moreover, a Setup XVI is different from the Setup XII in that the polarization element 104 is arranged in a different position, but the same as the Setup XII in other terms. Therefore, even in the Setup XV, (−M₁₃+M₁₄) is extracted.

As described above, either one of, or a sum of, or subtraction of the elements M₁₃, M₁₄, which may reflect the polarization characteristics due to the asymmetric structure within the wafer W among the Mueller matrix elements, can be extracted by combining various types of polarization light. Because whether any one of the elements greatly reflects particular polarization characteristics is dependent on types of asymmetric structures within the wafer W, measurement accuracy may be improved by combining appropriately types of polarization light.

### Modification of Measurement Apparatus

Next, explanations are made about modification of an optical measurement system of the measurement apparatus according to the above embodiment(s). FIG. 10 is a schematic view illustrating modification of an optical measurement system of the measurement apparatus according to the above embodiment(s). An optical measurement system 10A in this modification includes a light source 102A, a polarization element 104A, a stage 106, and the optical detector 108. A wavelength selection element 110A is provided between the light source 102 and the polarization element 104A. Because the stage 106 and the optical detector 108 are the same as those used in the optical measurement system 10 of the above-described measurement apparatus 1 (FIG. 2), repetitive explanation is omitted.

The light source 102A is a linear light source where, for example, multiple white light LEDs are arranged linearly. With this, linear white light is produced as a whole by white light emitted from each of the multiple white light LEDs. The light source 102A has a longitudinal length that is longer than or equal to a diameter of the wafer W held by the stage 106. The light source 102A is arranged by a predetermined supporting jig (not illustrated) in a position higher than the stage 106, with a light emitting surface thereof facing the stage 106. Additionally, the light source 102A is movable forward and backward in at least in a horizontal direction by the supporting jig that may be driven by a driving mechanism (not illustrated). With such a configuration, the light source 102A can move along a direction from one edge of the wafer W on the stage 106, the one edge being farthest from the optical detector 108, through the other edge of the wafer W on the stage 106, the other edge being nearest to the optical detector 108, while emitting the light. With this, an entire surface of the wafer W held by the stage 106 is illuminated with the light from the light source 102A. In a period of time during which the light source 102A illuminates the entire surface of the wafer W while moving, the image sensor of the optical detector 108 may be in an exposure state.

Incidentally, the light source 102A may have a lamp such as a high-pressure mercury lamp, a halogen lamp, a xenon lamp, instead of the white LEDs.

The wavelength selection element 110A and the polarization element 104A are arranged between the light source 102A and the stage 106. The wavelength selection element 110A and the polarization element 104A each have a rectangular shape corresponding to the shape of the light source 102A, and allow the white light from the light source 102A to be transmitted entirely therethrough. With this, the wafer W on the stage 106 may be illuminated with light having a predetermined wavelength and a predetermined polarization state.

Incidentally, even in this modification, the wavelength selection element 110 and the polarization element 104 that are illustrated in FIG. 2 may be arranged so as to face the light receiving surface of the optical detector 108, without using the wavelength selection element 110A and the polarization element 104A.

Additionally, the light source 102A may be configured by LEDs that emit light of a predetermined wavelength, such as ultraviolet region light, blue light, green light, yellow light, or red light. In this case, the wavelength selection element 110A (110) are not necessary.

Moreover, the light source 102A may be configured by multiple semiconductor laser elements arranged in one direction. In this case, an optical system may be used which is capable of spreading the laser beam from each of the multiple semiconductor laser elements in a direction perpendicular to the laser light propagating direction.

Even in this modification, the above-described measurement method can be performed, and thus asymmetric structures within the wafer W can be measured. Namely, the advantageous effects of the above-described measurement method may be demonstrated by this modified measurement apparatus.

While various embodiments and their modifications have been described as above, these embodiments and modifications have been presented by way of example only, and are not intended to limit the scope of the accompanying claims. The novel embodiments and modifications described herein may be embodied in various other forms; furthermore, various omissions, substitutions and modifications in the form of the embodiments may be made without departing from the spirit of the inventions. The accompanying claims and their equivalents are intended to cover such forms or modifications as would fall within the scope and spirit of the inventions.

Such modifications or alterations may be exemplified as follows. The wavelength selection element 110 (FIG. 2) may be arranged between the polarization element 104 and the stage 106, instead of between the light source 102 and the polarization element 104 in the above explanation. Similarly, the wavelength selection element 110A (FIG. 10) may be arranged between the polarization element 104A and the stage 106, instead of between the light source 102A and the polarization element 104A. Additionally, the wavelength selection element 110 (or 110A) may be arranged between the stage 106 and the optical detector 108.

Additionally, while the bandpass filter serving as the wavelength selection element is used to convert light from the light source 102 into a monochromatic light in the above embodiment(s), a spectroscope may be used instead of the bandpass filter. In this case, it is thought that the light from the light source 102 is guided into the spectroscope; and light emitted from the spectroscope is guided to the polarization element 104 through a predetermined optical system. Here, the optical system may be designed so that light transmitted through the polarization element 104, (i.e., the incident light) illuminates an entire surface of the wafer W. Moreover, the spectroscope may be provided between the stage 106 and the optical detector 108. In this case, a light-collecting optical system having one or more lenses may be used to collect the reflection light from the wafer W into the spectroscope.

The Mueller matrix elements that may reflect the polarization characteristics due to asymmetric structures may vary in magnitude depending on not only polarization characteristics but also wavelengths of the incident light. Therefore, when the inclination amount is calculated multiple times with various wavelengths produced by the spectroscope, measurement accuracy may be improved. Additionally, when it has been known that a particular one of the Mueller matrix elements is influenced relatively greatly by a particular wavelength of the incident light, depending on types of asymmetric structures within the wafer W, a wavelength of the incident light may be selected accordingly. Additionally, the wafer W on the stage 106 may be illuminated with white light, without using the wavelength selection element or the spectroscope, in certain instances.

In some of the above embodiments, the wafer W that has been in the first arrangement is moved to be in the second arrangement by rotating the stage 106, prior to the third imaging. However, the light source 102 and/or the optical detector 108 may be rotated with respect to the stage 106 so that the wafer W in the first arrangement is moved to be in the second arrangement in relative terms.

Although various measurement conditions have been explained referring to the table of FIG. 9, this table does not necessarily encompass all conditions. The measurement method according to embodiments may be performed in accordance with a measurement condition that is not listed in the table. For example, the polarization element 104 may be configured of various linear polarization elements and wavelength plates to produce various types of polarization light. Specifically, two types of polarization light in the complementary relationship, each of which has the elements S₃, S₄ of the Stokes Vector that have the same absolute value and different signs between in the first (third) and the second (fourth) imaging, may be produced.

Additionally, in the measurement apparatus 1 according to the embodiments (including the modification), the controller 12 may create an inclination amount map (or a shift amount map) for the wafer W as the measurement target in accordance with an inclination amount in each pixel stored in the memory 14. Moreover, when the input/output device 22 is configured of a personal computer, the inclination amount map may be displayed on a display device of the personal computer. With this, it may be easily recognized that relatively larger inclination occurs at a particular area in the wafer W. Moreover, an inclination direction map may be created and displayed.

In the measurement apparatus 1 according to the embodiment (s) (including the modification), an apparatus setup may be discretionally selected based in the table of FIG. 9. For example, when the input/output device 22 is configured of a personal computer, the measurement conditions may be selected by clicking “SETUP” of the table displayed on a display device of the personal computer, using, for example, a computer mouse. Depending on such selection, signals indicating selected measurement conditions are sent to the controller 12 from the input/output device 22; and thus the controller 12 controls the light source 102, the wavelength selection element 110, the polarization element 104, the stage 106, and the optical detector 108 in accordance with the signals. With this, the measurement method can be performed with the selected measurement conditions.

The wafer W as a measurement target may be an in-process wafer in which non-volatile memories such as NAND flash memories or NOR flash memories are to be manufactured. Specifically, the wafer W may be a wafer in progress, which is finally turned to be the non-volatile memories in accordance with a predetermined semiconductor device manufacturing process. Such a wafer includes, for example, a memory hole that extends in a direction perpendicular to the wafer. Here, the memory hole is a hole for forming a memory cell string having multiple memory cells in series therein.

Incidentally, the asymmetric structure may include an inclined line in a line-and-space structure, without limiting to the inclined or shifted hole. When a direction along which a line (or a space) extends is known, the wafer W may only be arranged so that the direction is in agreement with an optical axis of the incident light. Namely, the wafer W may be arranged in such a manner, and the wafer W is imaged twice, under illumination of light of respective polarization states.

Incidentally, even in a case of the hole, when an inclination direction along which the hole is inclined is known, it is sufficient that the wafer W is illuminated with the light (incident light) in a direction perpendicular to the inclination direction. For example, when the inclination direction is known, an inclination amount is calculated with the wafer W illuminated with the incident light in a direction perpendicular to the inclination direction, for example, in accordance with the first embodiment. Additionally, when the inclination direction is known and the measurement method according to the third or the fourth embodiment is performed, the third imaging and the fourth imaging can be omitted. Namely, the light is incident onto the wafer in a direction perpendicular to the inclination direction in the first imaging and the second imaging; a difference value is taken between the reflection light intensities obtained in the first imaging and the second imaging; and then an inclination amount is calculated based on the difference value and the regression expression acquired separately.

Incidentally, while the wafer W is imaged entirely at a time in the above-described embodiments, multiple areas into which the entire surface of the wafer W is divided may be imaged separately. For example, quadrant areas of the upper surface of the wafer W may be sequentially (four times) imaged in the first (third) and the second (fourth) imaging. Additionally, a minimum area to be imaged may be a chip area of a chip to be formed in the wafer W.

What is claimed is:

1. A measurement apparatus comprising:
a wafer stage having an upper surface on which a wafer to be measured is placed;
a light source capable of illuminating the upper surface with predetermined light;
a light detection portion configured to take an image of the wafer illuminated with the predetermined light by the light source;
a polarization element provided between the light source and the wafer stage, or between the wafer stage and the light detection portion; and
a controller,
wherein the controller is configured to
take a first difference value between a first signal and a second signal,
the first signal being generated by the light detection portion, based on a first reflection light from the wafer on the wafer stage, the wafer being illuminated along a first direction by the light source, the first reflection light having a first polarization state,
the second signal being generated by the light detection portion, based on a second reflection light from the wafer on the wafer stage, the wafer being illuminated along the first direction by the light source, the second reflection light having a second polarization state different from the first polarization state, and
identify an asymmetric structure of a pattern within the wafer, based on the first difference value and a regression expression, and
wherein the polarization element is set such that
a first element and a second element of a first Stokes Vector expressing the first polarization state are same as a first element and a second element of a second Stokes Vector expressing the second polarization state, respectively.

2. The measurement apparatus according to claim 1, wherein the controller is further configured to
take a second difference value between a third signal and a fourth signal,
the third signal being generated by the light detection portion, based on a third reflection light from the wafer on the wafer stage, the wafer being illuminated along a second direction different from the first direction by the light source, the third reflection light having the first polarization state, and
the fourth signal being generated by the light detection portion, based on a fourth reflection light from the wafer on the wafer stage, the wafer being illuminated along the second direction by the light source, the fourth reflection light having the second reflection state, and
wherein the controller is configured to identify the asymmetric structure, based on the first difference value, the second difference value, and the regression expression.

3. The measurement apparatus according to claim 2,
wherein the first direction and the second direction are different by 90° from each other, and
wherein the controller is configured to, based on the regression expression and a vector that is defined by the first difference value as one coordinate value and the second difference value as the other coordinate value in plane coordinates, obtain a magnitude of the vector.

4. The measurement apparatus according to claim 2,
wherein the first direction and the second direction are different by 90° from each other, and
wherein the controller is configured to obtain a magnitude of a vector defined by a first value as one coordinate value, the first value being obtained based on the regression expression and the first difference value, and a second value as the other coordinate, the second value being obtained based on the regression expression and the second difference value, in plane coordinates.

5. The measurement apparatus according to claim 1, wherein the polarization element is set such that at least one of a third element and a fourth element of the first Stokes Vector has a same absolute value as and a different sign from a corresponding one of a third element and a fourth element of the second Stokes Vector.

6. The measurement apparatus according to claim 1, wherein the polarization element is set such that
a third element of the first Stokes Vector and a fourth element of the second Stokes Vector has a same absolute value, and
a fourth element of the first Stokes Vector and a third element of the second Stokes Vector are zero.

7. The measurement apparatus according to claim 5, wherein
the first polarization state is a polarization state of +45° linearly polarized light, and
the second polarization state is a polarization state of −45° linearly polarized light.

8. The measurement apparatus according to claim 5, wherein
the first polarization state is a polarization state of right circularly polarized light, and
the second polarization state is a polarization state of left circularly polarized light.

9. The measurement apparatus according to claim 6, wherein
the first polarization state is a polarization state of +45° linearly polarized light, and
the second polarization state is a polarization state of right circularly polarized light.

10. The measurement apparatus according to claim 6, wherein
the first polarization state is a polarization state of +45° linearly polarized light, and
the second polarization state is a polarization state of left circularly polarized light.

11. The measurement apparatus according to claim 6, wherein
the first polarization state is a polarization state of −45° linearly polarized light, and
the second polarization state is a polarization state of right circularly polarized light.

12. The measurement apparatus according to claim 6, wherein
the first polarization state is a polarization state of −45° linearly polarized light, and
the second polarization state is a polarization state of left circularly polarized light.

13. The measurement apparatus according to claim 1, wherein the light source is configured to illuminate an entire upper surface of the wafer on the wafer stage.

14. The measurement apparatus according to claim 1, wherein the light detection portion is arranged such that an entire upper surface of the wafer on the wafer stage falls within a view field of the light detection portion.

15. A measurement apparatus comprising:
a wafer stage having an upper surface on which a wafer to be measured is placed;
a light source capable of illuminating the upper surface with predetermined light;
a light detection portion configured to take an image of the wafer illuminated with the predetermined light by the light source;
a polarization element provided between the light source and the wafer stage, or between the wafer stage and the light detection portion; and
a controller,
wherein the controller is configured to
take a first difference value between a first signal and a second signal,
the first signal being generated by the light detection portion, based on a first reflection light from the wafer on the wafer stage, the wafer being illuminated along a first direction by the light source, the first reflection light having a first polarization state, and
the second signal being generated by the light detection portion, based on a second reflection light from the wafer on the wafer stage, the wafer being illuminated along a direction opposite to the first direction by the light source, the second reflection light having the first polarization state, and
identify an asymmetric structure of a pattern within the wafer, based on the first difference value and a regression expression.

16. The measurement apparatus according to claim 15, wherein the controller is further configured to
take a second difference value between a third signal and a fourth signal,
the third signal being generated by the light detection portion, based on a third reflection light from the wafer on the wafer stage, the wafer being illuminated along a second direction different from both of the first direction and the direction opposite to the first direction by the light source, the third reflection light having the first polarization state, and
the fourth signal being generated by the light detection portion, based on a fourth reflection light from the wafer on the wafer stage, the wafer being illuminated along a direction opposite to the second direction by the light source, the fourth reflection light having the first polarization state, and
wherein the controller is configured to identify the asymmetric structure, based on the first difference value, the second difference value, and the regression expression.

17. The measurement apparatus according to claim 16,
wherein the first direction and the second direction are different by 90° from each other, and
wherein the controller is configured to, using the regression expression, obtain a magnitude of a vector or magnitudes of components of the vector, the vector being defined by the first difference value as one coordinate value and the second difference value as the other coordinate value in plane coordinates.

18. The measurement apparatus according to claim 17, wherein the controller is configured to further obtain an asymmetric direction of the asymmetric structure in the plane coordinates from a direction of the vector.

19. A measurement method comprising:
generating a first signal, based on a first reflection light from a wafer illuminated along a first direction by a light source, the first reflection light having a first polarization state;
generating a second signal, based on a second reflection light from the wafer illuminated along the first direction by the light source, the second reflection light having a second polarization state;
taking a difference value between the first signal and the second signal; and
identifying an asymmetric structure of a pattern within the wafer, based on the difference value and a regression expression,
wherein a first element and a second element of a first Stokes Vector expressing the first polarization state are same as a first element and a second element of a second Stokes Vector expressing the second polarization state, respectively.

20. The measurement method according to claim 19, wherein the regression expression indicates a relationship between the difference value and an inclination amount or a shift amount of the asymmetric structure, the difference value being obtained about a test wafer having a same type of the pattern of the asymmetric structure within the wafer, and the inclination amount or the shift amount being obtained through a cross-sectional observation of the test wafer.
